(19) United States
(12) Patent Application Publication
(10) Pub. No.: US 2017/0177189 A1
(43) Pub. Date: Jun. 22, 2017

(54) Method and System for Capturing Data on Display Using Scanner Pen

(71) Applicant: Radean T. Anvari, Tustin, CA (US)

(72) Inventor: Radean T. Anvari, Tustin, CA (US)

(21) Appl. No.: 14/975,762

(22) Filed: Dec. 19, 2015

(51) Int. Cl. G06F 3/0487; G06F 3/038; G06F 3/0484; G06F 3/0354; G06F 3/16

(52) U.S. Cl. CPC G06F 3/0487; G06F 3/03545; G06F 3/167; G06F 3/04845; G06F 3/0386; G06F 2203/0381

(57) ABSTRACT

In one example, we describe a method and system for a pen-shaped scanner that highlights the text or data, e.g., with different colors, e.g., yellow and red. In one example, it can read the handwriting. In one example, it can read the written text. In one example, the highlighted section(s) get loaded into a text editing module for conversion to text by word processing module. In one example, it transmits the data wirelessly. In one example, it transmits the data by cable or optically. In one example, it selects a text portion to highlight or extract. In one example, it has the memory for storage in the pen. In one example, it has local storage. In one example, it has extra storage outside the pen for bigger space for storage. In one example, it can be used for scanning a newspaper or book.

### BACKGROUND OF THE INVENTION

The scanners are very well accepted as the systems and methods of capturing images or data. But the current technology does not address many of the user's needs and requirements, including convenience and speed. However, the invention and embodiments described here, below, addresses those issues and needs, which have not been addressed or presented in any prior art.

### SUMMARY OF THE INVENTION

In one embodiment, we describe a method for a pen-shaped scanner that highlights the text or data, e.g., with different colors, e.g., yellow and red. In one embodiment, it can read the handwriting. In one embodiment, it can read the written text. In one embodiment, the highlighted section(s) get loaded into a text editing module for conversion to text by word processing module. In one embodiment, it transmits the data wirelessly.

In one embodiment, it transmits the data by cable or optically. In one embodiment, it selects a text portion to highlight or extract. In one embodiment, it has the memory for storage in the pen. In one embodiment, it has local storage. In one embodiment, it has extra storage outside the pen for bigger space. In one embodiment, it can be used for scanning a newspaper or book. In one embodiment, it can be used for scanning the wall or blackboard or sign on the wall or poster on the wall or picture on display of a device or display of computer or any other display or board or tablet or frame.

### BRIEF DESCRIPTION OF THE DRAWINGS

FIG. 1 is for one embodiment, as an example, for a pen scanner device.

FIG. 2 is for one embodiment, as an example, for a pen scanner device, with telescopic folding structure for length adjustment and easy storage.

FIG. 3 is for one embodiment, as an example, for a system platform for scanner device.

FIG. 4 is for one embodiment, as an example, for a pen scanner device working on a wall.

FIG. 5 is for one embodiment, as an example, for a spot scanner device.

FIG. 6 is for one embodiment, as an example, for a line scanner device.

FIG. 7 is for one embodiment, as an example, for a matrix or multi-line scanner device.

FIG. 8 is for one embodiment, as an example, for a method of a function for pen scanner device.

FIG. 9 is for one embodiment, as an example, for a pen scanner device, with adjustable 4 lasers or pointers or markers.

FIG. 10 is for one embodiment, as an example, for a pen scanner device, with adjustable source of light and slit opening, for projection on the wall.

### DETAILED DESCRIPTION OF THE PREFERRED EMBODIMENTS

In one embodiment, the scanner is at the tip of the pen, as a small window, in shape of square, circle, or rectangle. In one embodiment, the scanner at the side of the pen structure/shape/form, as a line scanner, as a long rectangle, with a narrow width for 1-3 lines of scan at a time. In one embodiment, we use that as stylus for a computer. In one embodiment, we use that as a mouse or marking or selector device for a computer.

In one embodiment, it has a light or laser for pointing on the wall or screen. In one embodiment, it has a roller at the top of the device. In one embodiment, it has a serial input, e.g., for keyboard and mouse. In one embodiment, it has a pen in it at the other end. In one embodiment, it has a laser at the other end for pointing, or at both ends.

In one embodiment, it has a combo version for pen and scanner plus laser. In one embodiment, it can be attached to a pocket holder or belt or shirt or lab coat, with a holder or hook or the like. In one embodiment, it has laser, diode, light, or any other type of light emitting device. In one embodiment, it can scan from far, from the text or image on the wall, e.g., from 5-50 ft distance.

In one embodiment, we have an antenna on the pen, for transmission of data, in parallel or inside the pen structure, or cylinder shaped structure. In one embodiment, we have scanner or camera on the pen in middle long axis of the length of the pen/device, and a marker or laser on the top of the pen in parallel, attached for marking on the wall. In one embodiment, we have the wall in the classroom or electronic display on a lecture hall or other displays in a mall, as static or dynamic displays, with markings on the wall, e.g., as mesh or cm or inch markings or ruler on the wall or projected by light on the wall or printed on the wall or poster on the wall or matrix of horizontal and vertical lines for measured distances and markers on the wall.

In one embodiment, we have shapes as circular or cone on screen to display. In one embodiment, we can measure the size on the wall from the inch-markers or distance markers, or alternatively, by knowing/measuring the distances to the wall, using an optical or laser or acoustic device to measure those distances to the wall, from the user's location or pen's location or coordinate in the lecture hall or room, using those conventional devices that are added or attached to the top of the pen-scanner or device.

In one embodiment, we have WiFi or Bluetooth devices or other wireless connections, for the pen-device. In one embodiment, we have the scan in real time. In one embodiment, it selectively scans the wall or poster or frame. In one embodiment, it selectively scans based on highlighted region. In one embodiment, it selectively scans to highlight a region. In one embodiment, it selectively scans only a section of the text or image or data or region on the wall, based on markers or highlighter or different color markers or point markers, as permanent or temporary markers on the wall or screen or display or poster or board.

In one embodiment, it selectively scans only a portion of the page. In one embodiment, it scans and recognizes the message or data on the wall. In one embodiment, it selectively scans and points with a marker or light at the same location or region on the wall. In one embodiment, it selectively scans and points with a marker or light at different locations or regions on the wall.

In one embodiment, it selectively scans and points with a marker or guiding light at a point on the wall or a cone shape projection or a circle or oval or ellipse cross section or projection or trace on the wall. In one embodiment, it selectively scans only the marked region and converts that with OCR (optical character recognition) to text, using the conventional modules in the market for this purpose. In one embodiment, it selectively scans and converts to text on a display of a computer, with selected region highlighted in the text version in the file on that computer.

In one embodiment, it converts voice to text. In one embodiment, it scans from far, to convert text to text, or handwriting to text, or text to handwriting fonts, based on specific person's handwriting, converted to fonts, alphabet units, for later use as combination of them, which was scanned and sorted out beforehand, for such a purpose.

In one embodiment, it has inside pen and outside pen memory units. In one embodiment, it uses voice commands which will be translated to words or text for writing output, or other languages, using a dictionary. In one embodiment, it previews the voice command or text translation on the display of a computer, connected to pen wirelessly or by cable, for user to see, or cut-paste/edit, in a text or word processing module or format.

In one embodiment, the pen has microphone and speaker on it. In one embodiment, it has a camera on the device, e.g., near one tip or end. In one embodiment, it can recline back to the pen, as its shelf or container or housing, e.g., using a spring action or small railings inside the pen or its wall, so that when pressed down, the camera will come out, and the reverse, for next action/pressing or pulling out by fingers, for a spring-like action.

In one embodiment, it has a removable memory units for exchange on the pen, e.g., memory sticks or flash memory. In one embodiment, it puts a date stamp on all captured data and GPS location from GPS device on the pen, for future listing and sorting, or looking at history later on, e.g., on a computer. In one embodiment, it has a USB connection or serial inputs or parallel inputs on the pen, or wireless format, to connect to a server or backup storage or cloud or tel. or smart phone or tablet or server farm or laptop or PDA or smart watch or wearable device.

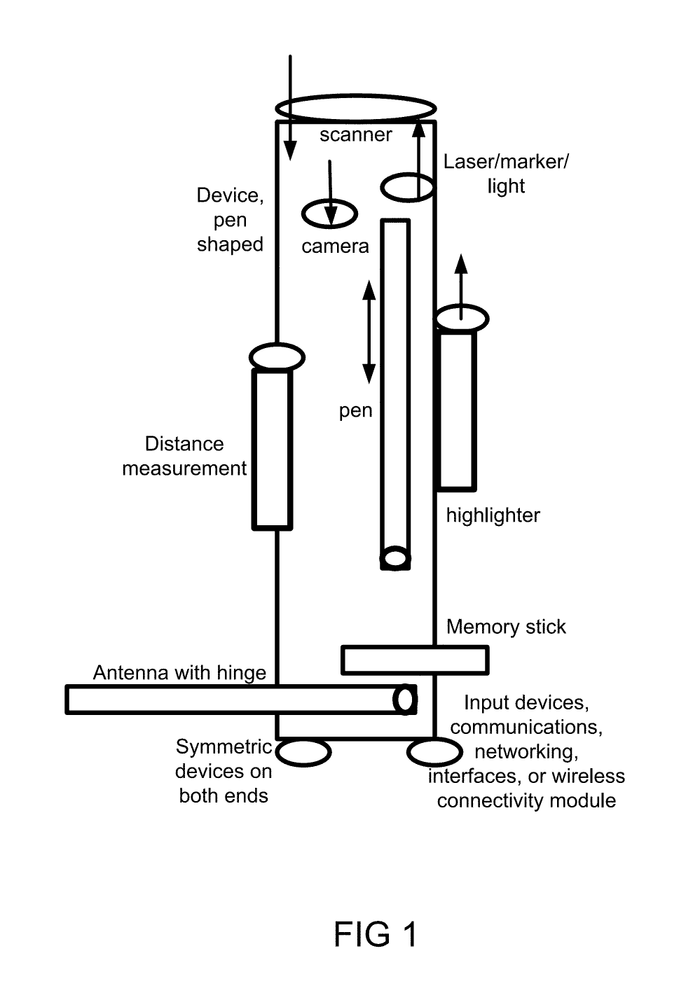

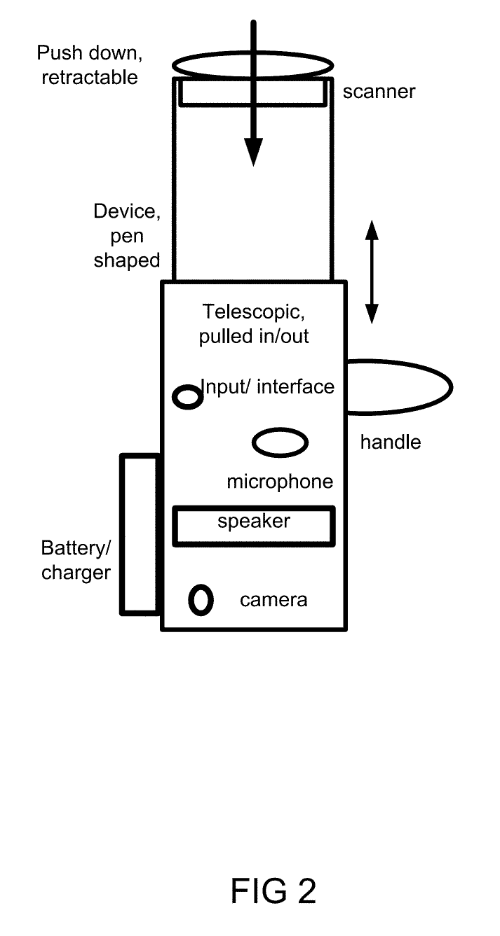

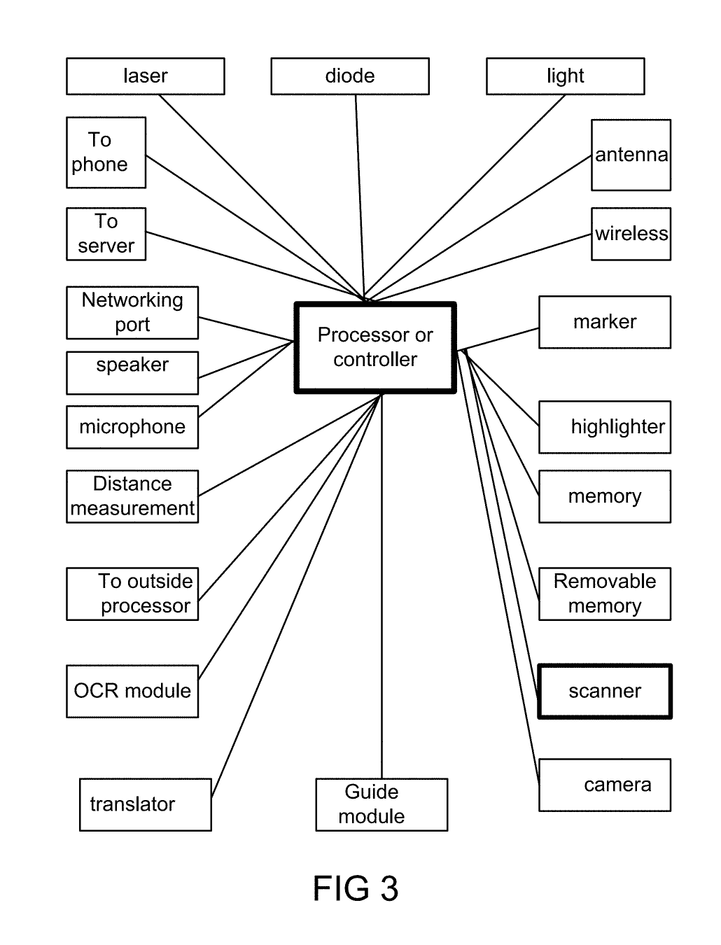

FIG. 1 is for one embodiment, as an example, for a pen scanner device. FIG. 2 is for one embodiment, as an example, for a pen scanner device, with telescopic folding structure for length adjustment and easy storage. FIG. 3 is for one embodiment, as an example, for a system platform for scanner device.

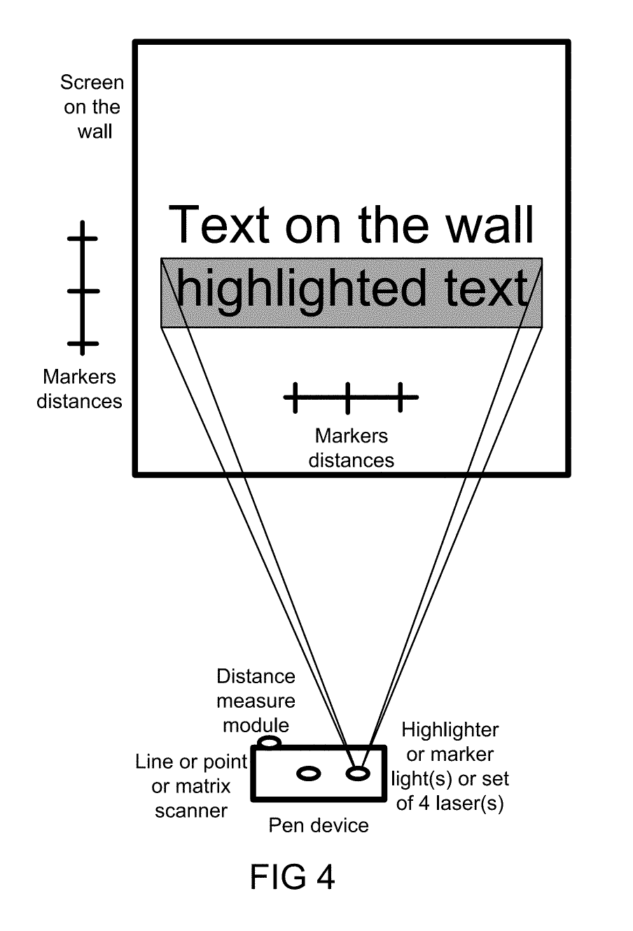

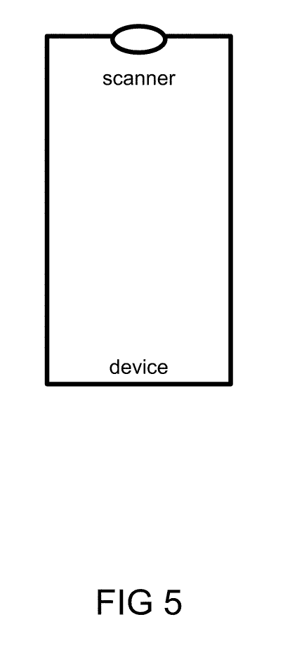

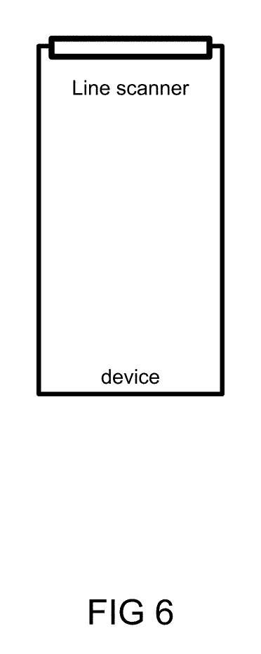

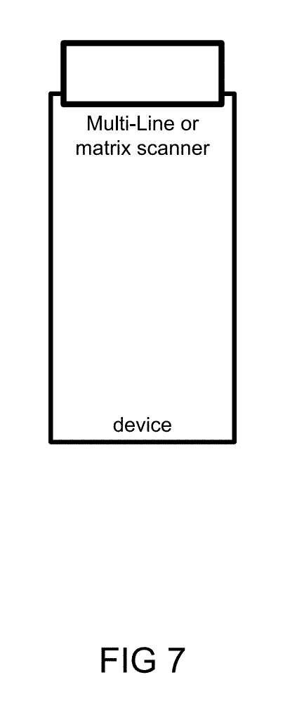

FIG. 4 is for one embodiment, as an example, for a pen scanner device working on a wall. FIG. 5 is for one embodiment, as an example, for a spot scanner device. FIG. 6 is for one embodiment, as an example, for a line scanner device. FIG. 7 is for one embodiment, as an example, for a matrix or multi-line scanner device.

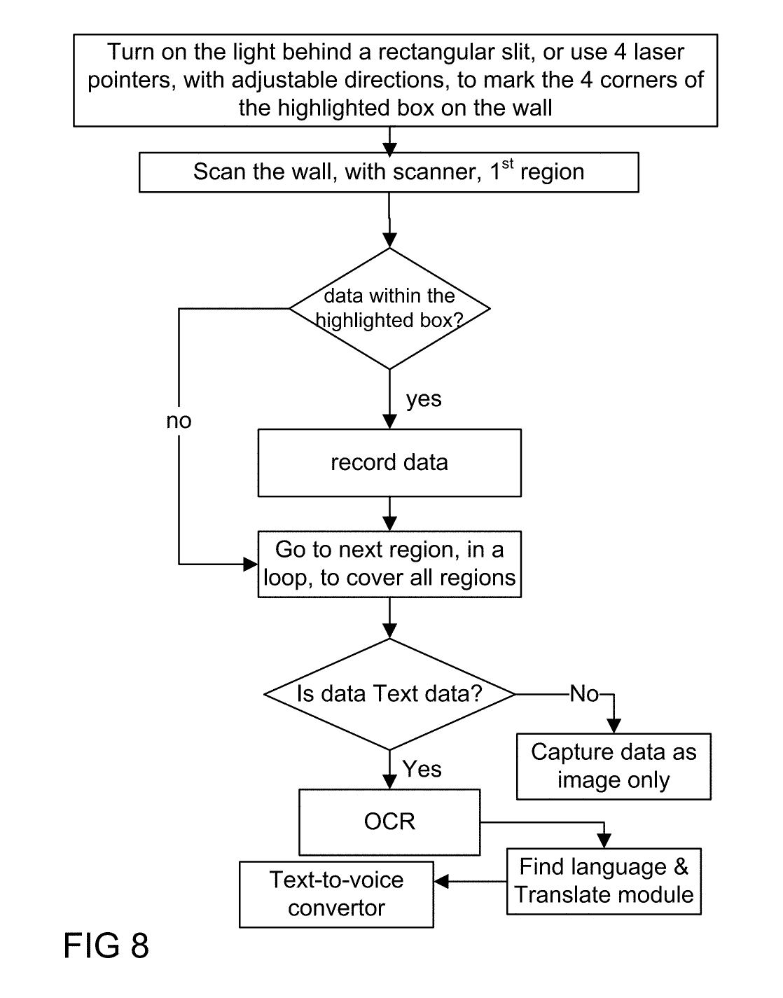

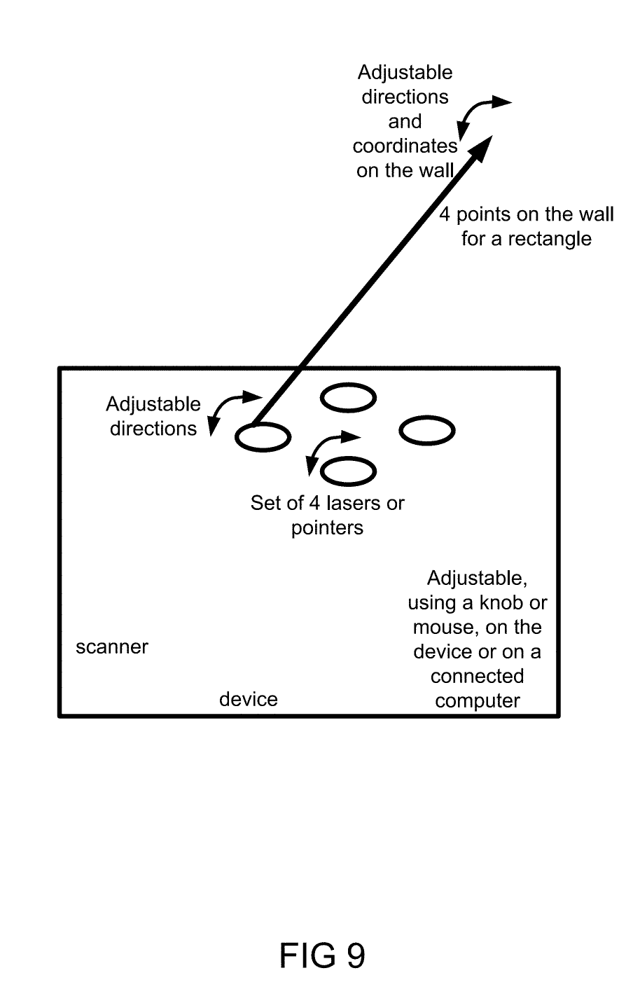

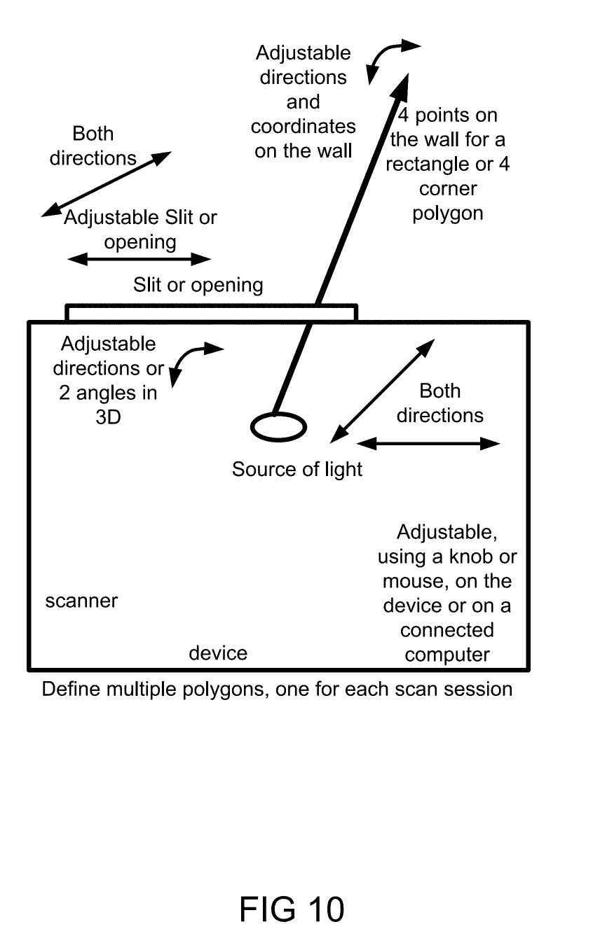

FIG. 8 is for one embodiment, as an example, for a method of a function for pen scanner device. FIG. 9 is for one embodiment, as an example, for a pen scanner device, with adjustable 4 lasers or pointers or markers. FIG. 10 is for one embodiment, as an example, for a pen scanner device, with adjustable source of light and slit opening, for projection on the wall.

In one embodiment, we have: A pen-shaped scanner device platform system, said platform system comprising: a cylindrical device; wherein said cylindrical device comprises a highlighter; wherein said cylindrical device comprises a scanner; wherein said cylindrical device comprises a distance measurement device; wherein said cylindrical device comprises an antenna; wherein said cylindrical device comprises a removable memory flash drive; wherein said cylindrical device comprises a set of 4 lasers; a knob or a mouse; wherein directions of said set of 4 lasers are adjusted by said knob or said mouse; a screen on a wall; wherein said screen comprises a 2 dimensional array or matrix of sensors of light sensitive elements; wherein said screen comprises a 2 dimensional array or matrix of elements activated as light elements by a command or instruction from an external computer; wherein said external computer communicates with said cylindrical device; wherein said knob or said mouse is connected to said external computer; wherein said cylindrical device comprises a telescopic structure; wherein said cylindrical device comprises a battery; wherein said cylindrical device comprises an electrical charger device; wherein said cylindrical device comprises a speaker; wherein said cylindrical device comprises a microphone; wherein said cylindrical device comprises a retractable tip; wherein said cylindrical device comprises a camera; wherein said cylindrical device comprises a wireless communication device; wherein said cylindrical device comprises a processor; wherein said cylindrical device comprises a permanent memory device; wherein said cylindrical device comprises an optical character recognition module; wherein said cylindrical device comprises a translator module; wherein said cylindrical device comprises a language determination module; wherein said cylindrical device comprises a display; wherein said screen comprises markers for distances on 2 dimensional directions; wherein first data is displayed on said screen; wherein a first part of said first data is highlighted on said screen; wherein only said first part of said first data is captured by said scanner; wherein said first part of said first data is sent to said optical character recognition module; wherein said first part of said first data is sent to said language determination module; wherein said first part of said first data is sent to said translator module; wherein said first part of said first data is sent to a text-to-voice conversion module; wherein said first part of said first data is sent to said external computer for displaying text and outputting voice, coming from said translator module and said text-to-voice conversion module, with the following options:

a handle.

a light source.

a slit.

an adjustable handle.

an adjustable light source.

an adjustable light source with horizontal adjustment.

an adjustable light source with vertical adjustment.

an adjustable light source with angular adjustment.

an adjustable slit.

an adjustable slit with horizontal adjustment.

an adjustable slit with vertical adjustment.

an adjustable slit with angular adjustment.

an adjustable slit with 3-D adjustment.

an adjustable slit with 2-D adjustment.

a retractable antenna.

an antenna inside said cylindrical device's housing.

a flash light.

a pen.

a tripod.

In one embodiment, it has a connection or includes a dictionary of another language for conversion of the text or voice to text or voice of a 2^{nd} language, as a scanner/translator combo, pocket pen dictionary, compact for travels, for tourists for fast understanding of the situation or texts, as we call it PocketTourist, a dictionary/scanner device, e.g., to read signs or directions or menus in restaurants or metro stations, from far, a few meters from the sign/text.

In one embodiment, the tip of the pen is scanner, or reader, with some light to show where we are on the text/image/sign on the wall, as a guide, located at the tip, close to scanner. In one embodiment, it types the text as it scans in real time, very fast. In one embodiment, it has a chip and a processor or microprocessor or field-programmable gate array (FPGA) or controller or logic board or computer or computing module or automation device, on the pen or inside that.

In one embodiment, the pen size is from about 2″ to 1′ length, or longer, with retractable housing, or telescopic housing shape. In one embodiment, the device looks like a ruler. In one embodiment, it looks like a long rectangular cube shape, or 2 inverted or regular cone shapes, or semi-sphere shape.

In one embodiment, the screen/wall has an array in 2D or matrix in 2D of sensors elements for light or laser, so that they act as pixels activated when hit with a light from pen-device or scanner-device. So, it will get the coordinates of the corners of the polygon or rectangle on the wall from those sensors' locations/coordinates. This can be verified by the other methods, mentioned above. In one embodiment, the screen/wall has a highlighting feature directly activated or marked from the computer or pen, without any light or laser shining on the wall or screen, activated on those pixel-sensors directly from the wall.

In one embodiment, only one laser is used, which is just for humans to see the point or center of region or square, for highlighting or extraction area, as a clue to see and estimate the region, but not necessarily needed to actually highlight anything on the screen. Then, from the direction of pen and/or laser, we can and will know the region of interest for pickup the image or data. Then, the scanner gets that region scanned only, limiting the area by itself, e.g., limited inside the processor of the scanner/pen.

In one embodiment, scanning and translation are done for a restaurant menu, map direction, metro direction, book, street sign, poster, wall posting, ad on the highway, or the like. In one embodiment, the scanner device has a display on itself or on a connected computer, with a wireless or wired or optical connection, to display text or image or data, or use sound or voice from a speaker, on one of those devices or on both.

Any variations of the above teaching are also intended to be covered by this patent application.

1. A pen-shaped scanner device platform system, said platform system comprising:
a cylindrical device;
wherein said cylindrical device comprises a scanner;
wherein said cylindrical device comprises a distance measurement device;
wherein said cylindrical device comprises a set of 4 lasers;
a knob or a mouse;
wherein directions of said set of 4 lasers are adjusted by said knob or said mouse;
a screen on a wall;
wherein said screen comprises a 2 dimensional array or matrix of light sensors;
wherein said screen comprises a 2 dimensional array or matrix of light elements activated by a command or instruction from an external computer;
wherein said external computer communicates with said cylindrical device;
wherein said knob or said mouse is connected to said external computer;
wherein said cylindrical device comprises a camera;
wherein said cylindrical device comprises a processor;
wherein said cylindrical device comprises an optical character recognition module;
wherein said optical character recognition module is connected to said processor;
wherein said cylindrical device comprises a display;
wherein said screen comprises markers for distances on 2 dimensional directions;
wherein first data is displayed on said screen;
wherein said set of 4 lasers shine on said screen, hit said 2 dimensional array or matrix of light sensors on said screen, and mark 4 corners of a highlighted rectangle on said screen;
wherein said 4 corners of said highlighted rectangle on said screen correspond to said 2 dimensional array or matrix of light elements activated by said set of 4 lasers shining on said screen;
wherein a first part of said first data is highlighted on said screen by said highlighted rectangle;
wherein only said first part of said first data is captured by said scanner;
wherein said first part of said first data is sent to said optical character recognition module to recognize only said first part of said first data.

2. The pen-shaped scanner device platform system, as recited in claim 1, said platform system comprises: a handle.

3. The pen-shaped scanner device platform system, as recited in claim 1, said platform system comprises: a light source.

4. The pen-shaped scanner device platform system, as recited in claim 1, said platform system comprises: a slit.

5. The pen-shaped scanner device platform system, as recited in claim 1, said platform system comprises: an adjustable handle.

6. The pen-shaped scanner device platform system, as recited in claim 1, said platform system comprises: an adjustable light source.

7. The pen-shaped scanner device platform system, as recited in claim 1, said platform system comprises: an adjustable light source with horizontal adjustment.

8. The pen-shaped scanner device platform system, as recited in claim 1, said platform system comprises: an adjustable light source with vertical adjustment.

9. The pen-shaped scanner device platform system, as recited in claim 1, said platform system comprises: an adjustable light source with angular adjustment.

10. The pen-shaped scanner device platform system, as recited in claim 1, said platform system comprises: an adjustable slit.

11. The pen-shaped scanner device platform system, as recited in claim 1, said platform system comprises: an adjustable slit with horizontal adjustment.

12. The pen-shaped scanner device platform system, as recited in claim 1, said platform system comprises: an adjustable slit with vertical adjustment.

13. The pen-shaped scanner device platform system, as recited in claim 1, said platform system comprises: an adjustable slit with angular adjustment.

14. The pen-shaped scanner device platform system, as recited in claim 1, said platform system comprises: an adjustable slit with 3-D adjustment.

15. The pen-shaped scanner device platform system, as recited in claim 1, said platform system comprises: an adjustable slit with 2-D adjustment.

16. The pen-shaped scanner device platform system, as recited in claim 1, said platform system comprises: a retractable antenna.

17. The pen-shaped scanner device platform system, as recited in claim 1, said platform system comprises: an antenna inside said cylindrical device's housing.

18. The pen-shaped scanner device platform system, as recited in claim 1, said platform system comprises: a flash light.

19. The pen-shaped scanner device platform system, as recited in claim 1, said platform system comprises: a pen.

20. The pen-shaped scanner device platform system, as recited in claim 1, said platform system comprises: a tripod.
